(19) United States
(12) Patent Application Publication
(10) Pub. No.: US 2005/0239537 A1
(43) Pub. Date: Oct. 27, 2005

(54) Gaming machine

(75) Inventor: Takahiro Ogiwara, Tokyo (JP)

Correspondence Address: MCGINN & GIBB, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/113,331

(22) Filed: Apr. 25, 2005

(30) Foreign Application Priority Data
Apr. 26, 2004 (JP) P2004-129798

(51) Int. Cl. A63F 13/00

(52) U.S. Cl. 463/17

(57) ABSTRACT

A gaming machine includes: a game processing unit that provides a game of a type in which a plurality of players participate; a plurality of betting sections provided for each of the players, the betting section allowing the player to bet on a game result of the game provided by the game processing unit; and a lottery unit that performs a lottery for each of the betting sections, the lottery to win an occurrence of a special gaming state in which condition more advantageous than in a normal gaming state, wherein each of the betting sections includes an effect producing unit that produces a special effect when the special gaming state occurs in at least one of the betting sections.

### CROSS-REFERENCE TO THE RELATED APPLICATION(S)

The present application is based upon and claims a priority from a prior Japanese Patent Application No. 2004-129798 filed on Apr. 26, 2004, the entire contents of which are incorporated herein by reference.

### BACKGROUND OF THE INVENTION

1. Field of the Invention

The present invention relates to a gaming machine of the type wherein a plurality of players participate in a game for allowing a plurality of players to participate in a game with one gaming machine to play the game at the same time, such as a roulette gaming machine, a bingo gaming machine, or a horse race gaming machine, and in particular to a gaming machine of the type wherein a plurality of players participate in the game for more increasing a sense of anticipation of the player by effects provided at each of betting sections.

2. Description of the Related Art

A game in a gaming machine of the type wherein a plurality of players participate in a game using medals as game media, such as a roulette gaming machine, a bingo gaming machine, or a horse race gaming machine, is a game that can be started as the player purchases or borrows a plurality of medals with a medal lending machine and inputs the medal into the gaming machine. If the player wins the game, a predetermined number of medals are paid out to the player. Therefore, the player who can gain a large number of medals can enjoy continuously playing another game without purchasing or borrowing new medals.

Here, for example, in a roulette gaming machine, one of gaming machines of the type wherein a plurality of players participate in a game, the player plays a game by betting the medal purchased or borrowed with a medal lending machine on the mark from which the player expects a win. The player predicts the number on which a ball rotating on a roulette wheel will finally stop in the current game, and bets chips on the specified area. If the player won the game in the bet area, chips are paid out to the player in accordance with the number of the bet chips and a predetermined magnification.

Further, in some gaming machines of the type wherein a plurality of players participate in a game, the player is temporarily given an advantageous condition for the player such as an increase in the magnification of chips paid out when the player wins the game in betting chips. For example, JP-A-2001-162046 describes a bingo gaming machine for drawing lots called feature lottery by a bonus lottery section and giving the player an advantageous condition such as an increase in odds or an increase in the number of activated or effective areas at a given probability.

### SUMMARY OF THE INVENTION

However, in the bingo gaming machine described in JP-A-2001-162046, if an advantageous condition for a specific player is generated by the bonus lottery section, only the specific player given the generated advantageous condition can know the fact. That is, other players playing the game with the same gaming machine continue to play the game in the same game play condition as the normal state with no change made. The generation probability at which an advantageous condition will be generated for one player is limited to a given range because of the payout ratio, and the advantageous condition rarely generated makes the game monotonous and results in a decrease in the game play wish of the player.

It is therefore one of objects of the invention to provide a gaming machine of the type wherein a plurality of players participate in a game for providing a predetermined effect for all players playing a game with the same gaming machine if an advantageous condition occurs for at least one player for more increasing a sense of anticipation of the players for the game and enabling the players to continue to have interest in the game.

According to a first aspect of the invention, there is provided a gaming machine including: a game processing unit that provides a game of a type in which a plurality of players participate; a plurality of betting sections provided for each of the players, the betting section allowing the player to bet on a game result of the game provided by the game processing unit; and a lottery unit that performs a lottery for each of the betting sections, the lottery to win an occurrence of a special gaming state in which condition more advantageous than in a normal gaming state, wherein each of the betting sections includes an effect producing unit that produces a special effect when the special gaming state occurs in at least one of the betting sections.

According to a second aspect of the invention, there is provided a gaming method including: providing a game of a type in which a plurality of players participate; allowing each of the players to bet on a game result of the game with a plurality of betting sections respectively provided for each of the players; performing a lottery for each of the betting sections, the lottery to win an occurrence of a special gaming state in which condition more advantageous than in a normal gaming state; producing a special effect in each of the betting sections when the special gaming state occurs in at least one of the betting sections.

### BRIEF DESCRIPTION OF THE DRAWINGS

These and other objects and advantages of the present invention will be more fully apparent from the following detailed description taken in conjunction with the accompanying drawings, in which:

FIG. 1 is an external perspective view to show the schematic configuration of a roulette gaming machine according to an embodiment of the invention;

FIG. 2 is a plan view of a roulette wheel according to the embodiment;

FIG. 3 is a drawing to show a BET screen displayed on an image display;

FIG. 4 is a drawing to show a bonus lottery screen displayed on the image display;

FIG. 5 is a drawing to show the bonus lottery screen displayed on the image display;

FIG. 6 is a schematic representation to show a bonus lottery pattern table;

FIG. 7 is a perspective view to show the medal acceptance unit according to the embodiment;

FIG. 8 is a block diagram to schematically show a control system of the roulette gaming machine according to the embodiment;

FIG. 9 is a block diagram to schematically show a control system of a satellite according to the embodiment;

FIG. 10 is a schematic drawing to show storage areas of ROM of the roulette gaming machine according to the embodiment;

FIG. 11 is a schematic drawing to show storage areas of RAM of the roulette gaming machine according to the embodiment;

FIG. 12 is a flowchart of a normal roulette game processing program according to the embodiment; and

FIG. 13 is a flowchart of a lottery effect processing program according to the embodiment of the invention.

### DETAILED DESCRIPTION OF THE PREFERRED EMBODIMENTS

A gaming machine of the type wherein a plurality of players participate in a game according to the invention will be discussed in detail with reference to the accompanying drawings based on an embodiment of a roulette gaming machine 1 as the gaming machine.

The roulette gaming machine 1 is a gaming machine in which a player predicts a symbol such as a number or a character determined with rotation of a roulette wheel and bets desired credit points owned by the player on the predicted symbol, and when a ball stops on the symbol on which the credit points are bet, the player receives payout of a predetermined number of credit points. The credit points are gained by winning the game or by inputting game media such as medals and coins into the roulette gaming machine 1.

The plurality of symbols arranged on the roulette wheel may be arbitrary as far as each of the symbols can be discriminated from one another, and each of the symbols may be configured to have attribute including any of a plurality of numbers, a plurality of characters, a plurality of icons or figures, and a plurality of colors. In the following description, it is assumed that the symbols arranged on the roulette wheel have attribute of a plurality of numbers different from one another.

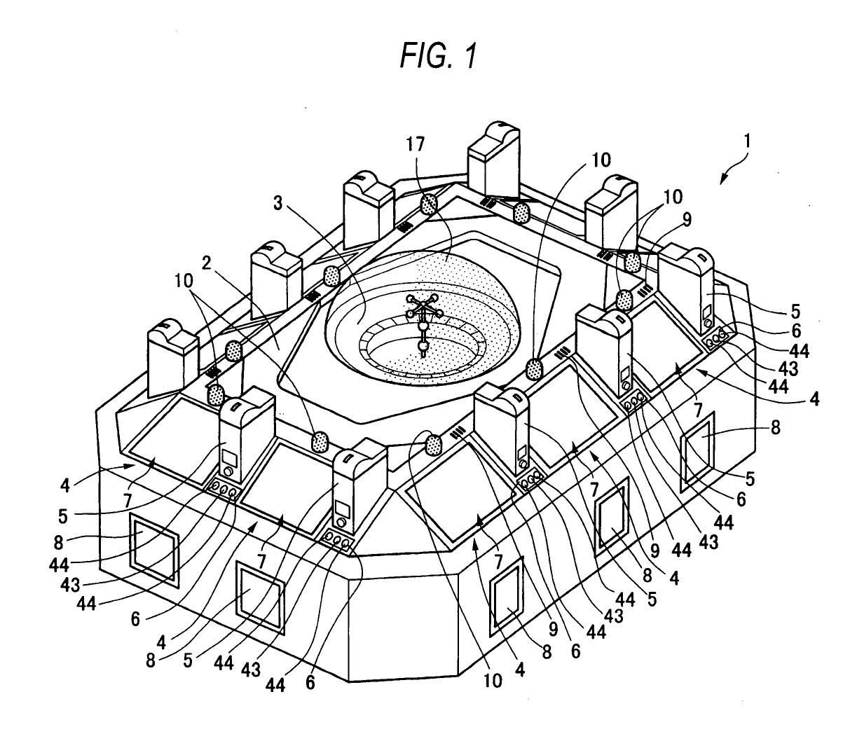

A schematic configuration of the roulette gaming machine 1 according to the embodiment will be described with reference to FIG. 1. FIG. 1 is an external perspective view to show the schematic configuration of the roulette gaming machine 1 according to the embodiment.

As shown in FIG. 1, the roulette gaming machine 1 basically includes a cabinet 2 of a main body, a roulette wheel 3 provided substantially in the center of the top face of the cabinet 2, and a plurality of (in the embodiment, ten) satellites (betting section) 4 placed so as to surround the roulette wheel 3.

The satellite 4 refers to a place to play a game and includes at least a medal acceptance unit (game media acceptance unit) 5 for inputting game media such as coins and medals for playing the game, a control section 6 including control buttons operated by the player to enter commands, and an image display (display unit) 7 for displaying an image involved in the game. The player operates the control section 6 while seeing the image displayed on the image display 7, to thereby play the game provided in the roulette wheel 3 and the image display 7.

Medal payout openings 8 are provided on the sides of the cabinet 2 where the satellites 4 are installed. A speaker 9 for producing music and effect sound is provided in the upper right portion of the image display 7 of each satellite 4.

Further, a WIN lamp 10 is provided above the image display 7 at each of the satellites 4. The WIN lamp 10 included in the satellite 4 where the award odds concerning payout of credit make a transition to an increase state (special gaming state) as compared with a normal state goes on, informing the surrounding players that the satellite 4 makes the transition to the special gaming state, as described later. Each WIN lamp 10 is placed at the position for enabling the players at all installed satellites 4 (in the embodiment, 10 satellites) to visually recognize the WIN lamp 10. Other players playing a game with the same roulette gaming machine 1 can always recognize that the WIN lamp 10 is lit.

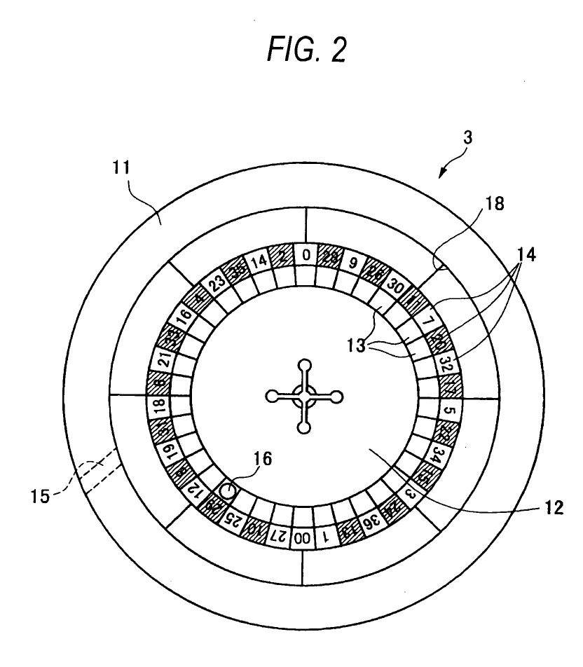

The configuration of the roulette wheel 3 according to the embodiment will be discussed with reference to FIG. 2. FIG. 2 is a plan view of the roulette wheel 3 according to the embodiment.

As shown in FIG. 2, the roulette wheel 3 basically includes a frame 11 fixed to the cabinet 2 and a rotation disk 12 housed and supported inside of the frame 11 for rotation. The rotation disk 12 is formed on the top face with a large number of (in the embodiment, thirty-eight) concave ball housing grooves 13. Number indication plates 14 indicating numbers of “0,” “00,” and “1” to “36” as graphic characters in a one-to-one correspondence with the ball housing grooves 13 are formed on the top face of the rotation disk 12 in the outer direction of the ball housing grooves 13.

A ball discharging port 15 is formed in the frame 11. A ball discharging unit (not shown) is joined to the ball discharging port 15 and a ball 16 is discharged onto the rotation disk 12 from the ball discharging port 15 by the ball discharging unit. The whole above the roulette wheel 3 is covered with a transparent acrylic cover member 17 substantially shaped in a hemispheric shape.

The frame 11 is inclined gently to the center and is formed in an intermediate portion with a guide wall 18 for guiding the discharged ball 16 against the centrifugal force and rolling the ball 16. As the rotation speed reduces and the centrifugal force is lost, the ball 16 rolls down the slope of the frame 11 and goes to the inside thereof and arrives at the rotating rotation disk 12.

The ball 16 rolling to the rotation disk 12 is housed in one of the ball housing groove 13 through the tops of the number indication plates 14 outside the rotating rotation disk 12, and the number described on the number indication plate 14 corresponding to the ball housing groove 13 in which the ball 16 is housed becomes the win number.

A win determination unit (not shown) is installed below the roulette wheel 3 for determining which number the ball is housed in the ball housing groove 13 corresponding thereto. Further, a ball collection unit is installed below the rotation disk 12 for collecting the ball 16 on the rotation disk 12 after each game is over. The ball discharging unit, the win determination unit, and the ball discharging unit are conventionally well known in the art and therefore will not be discussed in detail.

The configurations of the control section 6 and the image display 7 according to the embodiment will be discussed.

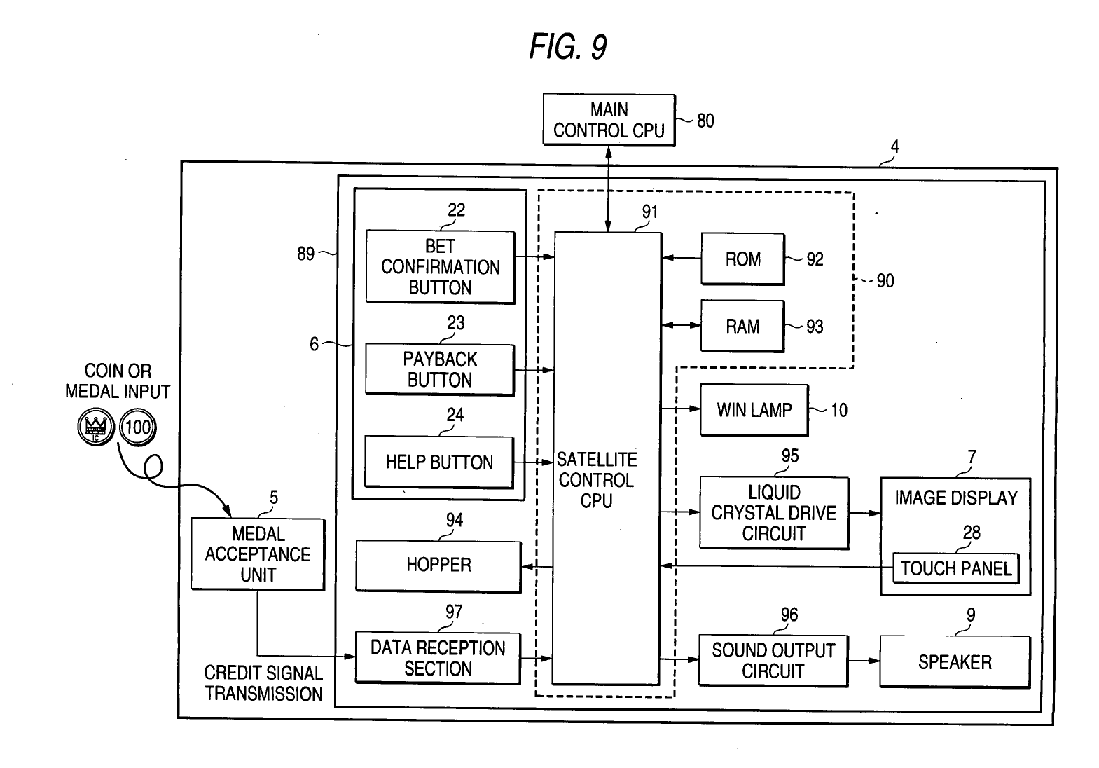

The control section 6 is provided on the side of the image display 7 of the satellite 4 and buttons operated by the player are placed, as shown in FIGS. 1 and 9. Specifically, a BET confirmation button 22, a payback (CASHOUT) button 23, and a help (HELP) button 24 are placed from the left to the right viewed from the position opposed to the satellite 4.

The BET confirmation button 22 is a button pressed by the player to confirm the bet after bet operation with the image display 7 described later. When the bet is confirmed and the player bets a chip on the number described on the number indication plate 14 corresponding to the ball housing groove 13 in which the ball 16 is housed on the roulette wheel 3 during the gaming, the player wins the game. When the player wins the game, credit points responsive to the number of the chips bet are added to the current owned credit points of the player. The bet operation is described later in detail.

The payback button 23 is a button to be pressed by the player when the player decides to end playing the game. When the player presses the payback button 23, medals responsive to the current owned credit points of the player, gained by the games, (normally, one medal to one credit points) are paid back to the player from the medal payout opening 8.

The help button 24 is a button to be pressed by the player when the player is unfamiliar with the rules and operation to play the game. When the player presses the help button 24, immediately a held screen indicating various pieces of operation information is displayed on the image display 7.

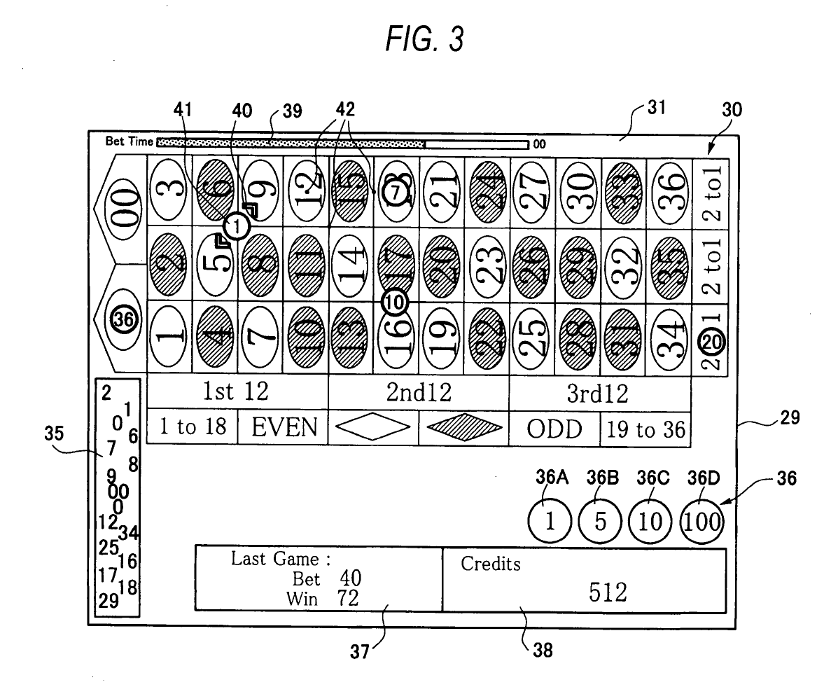

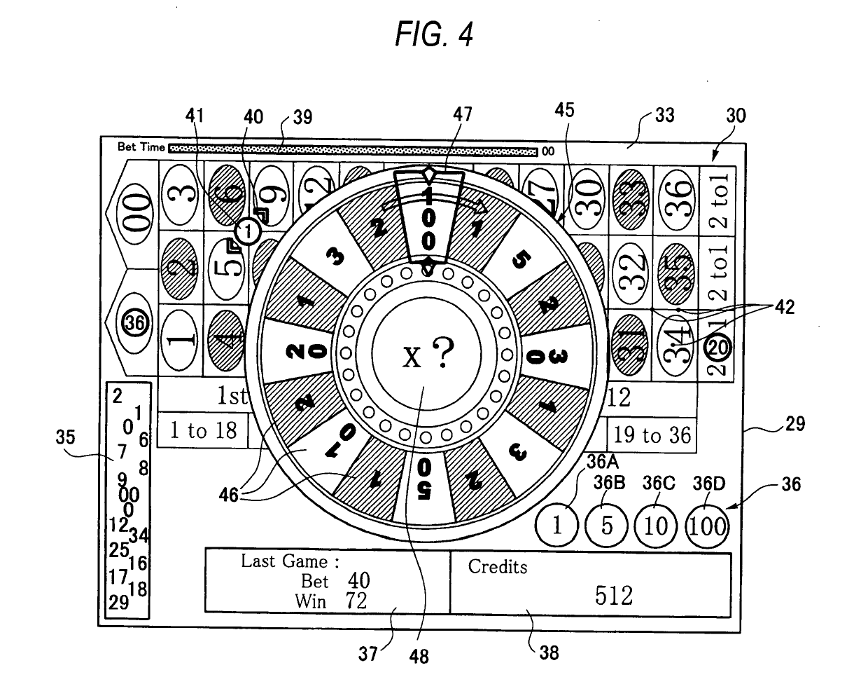

The image display 7 is a touch-panel liquid crystal display with a touch panel 28 attached to the front of the liquid crystal display. The player presses an icon displayed on a liquid crystal screen 29 with a finger to select the icon. FIGS. 3 and 4 are drawings to show examples of display screens displayed on the image display 7 during the gaming.

As shown in FIGS. 3 and 4, during the gaming with the roulette gaming machine 1, the image display 7 displays two types of screens of a BET screen 31 having a table betting board 30 for the player to predict the win number and bet a chip and a bonus lottery screen 33 for producing the effect of lottery as to whether or not a special gaming state for giving an advantageous condition to the player (which will be hereinafter referred to as bonus state) occurs after the chip bet period of the player expires.

The player can use the BET screen 31 to bet chips using the credit points owned by the player. If a specific result occurs on the bonus lottery screen 33 and the player wins the game in betting the chip on the BET screen 31, the player gains a larger number of credit points than the credit points to be gained in a normal state in the game, as described later.

The BET screen 31 will be discussed based on FIG. 3. The same numbers as the numbers “0,” “00,” and “1” to “36” indicated on the number indication plates 14 are arranged in grids on the table betting board 30 displayed on the BET screen 31. Special BET areas for the player to bet a chip by specifying “odd number,” “even number,” “color of number indication plate (red or black), or ”given number range (for example, “1” to “12” or the like) are also arranged in grids.

Displayed at a lower portion in the table betting board 30 are a result history display section 35, the above-mentioned screen switch button 34, betting section selection buttons 36, a payback result display section 37, and a credit points display section 38 from the left to the right of the screen.

The result history display section 35 lists the results of the win numbers in the previous games (one game refers to an operation sequence from the player betting a chip at each satellite 4 to the ball 16 dropping to the ball housing groove 13 to paying out credit based on the win number). When one game is over, a new win number is added to the top of the result history display section 35 to allow the player to check the history of the win numbers of a maximum of 16 games.

The betting section selection buttons 36 are buttons for allowing the player to bet chips on a BET area 42 (within a grid provided with numbers or characters or on a line forming the grid) specified by the player. The following four types of betting section selection buttons 36 are included: 1-BET button 36A, 5-BET button 36B, 10-BET button 36C, and 100-BET button 36D.

The player first specifies the BET area 42 with a cursor 40 described later by directly pressing the screen with a finger, etc. When the player presses the 1-BET button 36A, one chip is bet at a time (the number of bet chips increases such as “1”→“2”→“3” and so on each time the player presses the 1-BET button 36A with a finger). When the player presses the 5-BET button 36B, five chips are bet at a time (the number of bet chips increases such as “5”→“10”→“15” and so on each time the player presses the 5-BET button 36B with a finger). When the player presses the 10-BET button 36C, 10 chips are bet at a time (the number of bet chips increases such as “10”→“20”→“30” each time the player presses the 10-BET button 36C with a finger) When the player presses the 100-BET button 36C, 100 chips are bet at a time (the number of bet chips increases such as “100”→“200”→“300” and so on each time the player presses the 100-BET button 36D with a finger).

According to the above configuration, the betting operation can be simplified when betting a large number of chips.

The payback result display section 37 displays the number of bet chips of the player in the preceding game and the credit points to be paid-back (paid-back credit points). Here, subtracting the number of bet chips from the paid-back credit points results in the credit points newly gained by the player in the preceding game.

The credit points display section 38 displays the credit points presently owned by the player. When the player bets chips, the credit points is decremented by the number of the bet chips (one credit points per chip). If the player wins the game and the corresponding credit points are paid back, the credit points is incremented by the paid-back credit points. When the credit points owned by the player reaches 0, the game is over.

A BET timer graph 39 is provided at the upper portion of the table betting board 30. The BET timer graph 39 is a graph for indicating the remaining time during which the player is allowed to bet, and a red graph extends gradually to the right with the passage of time from the game start time. When the graph extends to the rightmost side, the time during which the player can bet in the current game expires. When the bet period of the player at each satellite 4 expires, namely, when the BET timer graph 39 reaches the rightmost side, the ball discharging unit discharges the ball 16 into the roulette wheel 3.

A cursor 40 indicating the BET area 42 presently selected by the player is displayed on the table betting board 30. A chip mark 41 indicating the number of chips bet and the selected BET area 42 so far is also displayed on the table betting board 30. The number displayed on the chip mark 41 denotes the number of chips bet. For example, the chip mark 41 displayed with a number “7” thereon placed on the grid “18” as shown in FIG. 3 indicates that the player bets seven chips on the number “18”. The betting method in which to bet a chip on a single number is called “straight up.”

The chip mark 41 displayed with a number “1” thereon placed at the intersection of the grids “5,” “6,” “8,” and “9” indicates that the player bets one chip on the four numbers covering “5,” “6,” “8,” and “9”. The betting method in which to bet a chip covering four numbers is called “corner bet.”

Other available betting methods are as follows: “Split bet” is a betting method in which to bet a chip covering two numbers on the line between two numbers (adjacent grids); “street bet” is a betting method in which to bet a chip covering three numbers (for example, “13,” “14,” and “15”) on the end of a horizontal row of the numbers (in FIG. 3, one row in the vertical direction); “five bet” is a betting method in which to bet a chip covering five numbers of “0,” “00,” “1,” “2,” and “3” on the line between the numbers “00” and “3”; “line bet” is a betting method in which to bet a chip covering six numbers (for example, “13,” “14,” “15,” “16,” “17,” and “18”) among numbers of two horizontal rows of the numbers (in FIG. 3, two rows in the vertical direction) ; “column bet” is a betting method in which to bet a chip covering 12 numbers on the grid written as “2 to 1;” and “dozen bet” is a betting method in which to bet a chip covering 12 numbers on the grid written as “1st 12,” “2nd 12,” or “3rd 12.” Further, betting methods each covering 18 numbers depending on the number indication plate color (red or black), odd or even number, whether the number is equal to or less than 18 or is equal to or more than 19 using six grids provided at the bottom stage of the table betting board 30 are also available. The betting methods differ in credit award (odds) per chip when the player wins the game in betting the chip (chips).

To bet a chip on the BET screen 31 described above, first the player specifies the BET area 42 (within a grid of a number or a character or on a line forming the grid) to bet on the screen and presses the BET area 42 directly with a finger. Consequently, the cursor 40 moves to the specified BET area 42.

Then, whenever the player presses one of the betting section selection buttons 36 (1-BET button 36A, 5-BET button 36B, 10-BET button 36C, 100-BET button 36D), as many chips as the number indicated by the betting section selection button are bet on the specified BET area 42. For example, when the player presses the 10-BET button 36C four times, the 5-BET button 36B once, and the 1-BET button 36A three times, a total of 48 chips is bet.

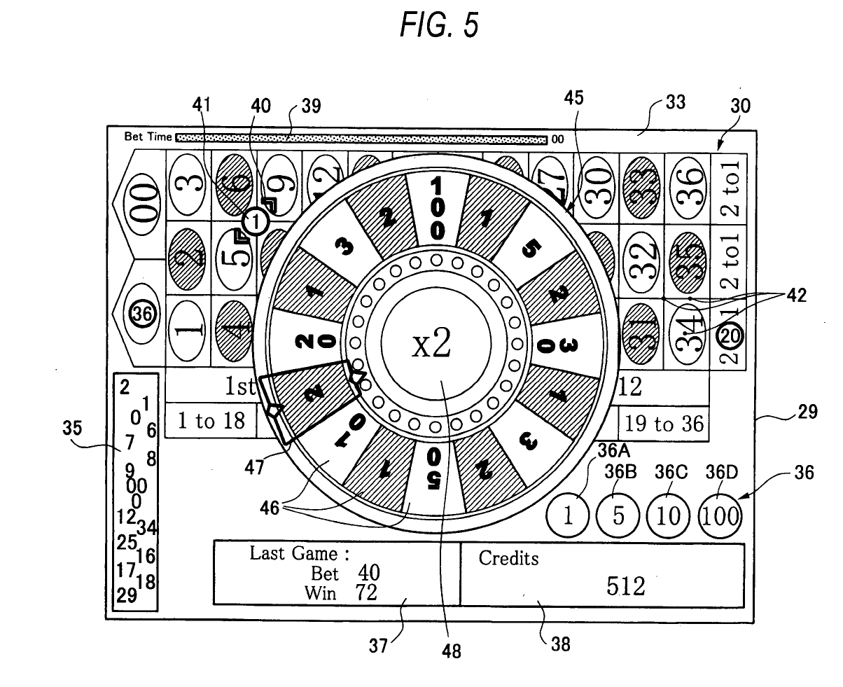

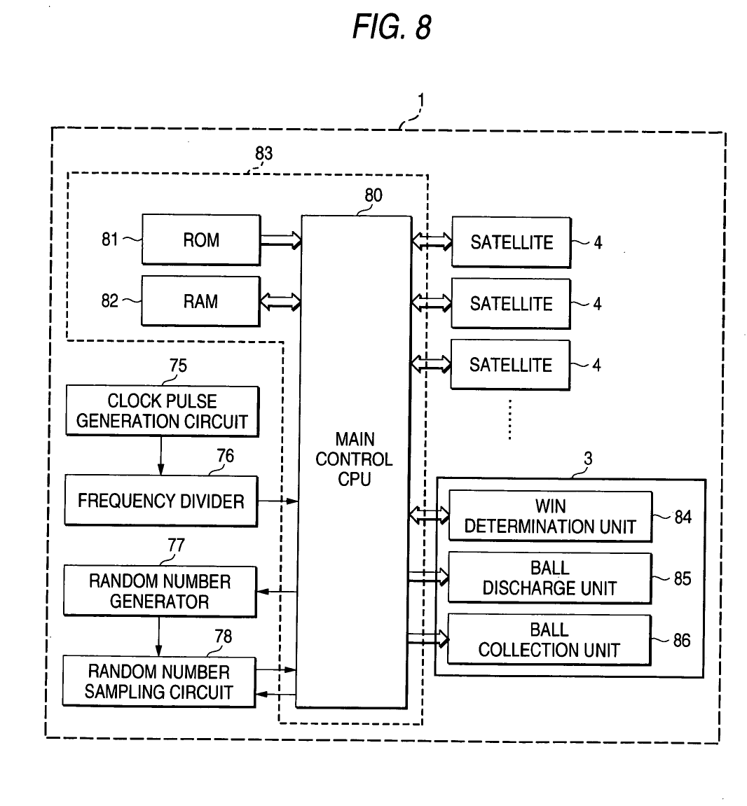

The bonus lottery screen 33 will be discussed based on FIGS. 4 and 5. After the bet period on the BET screen 31 expires, namely, when the BET timer graph 39 reaches the rightmost side, the BET screen 31 transits to the bonus lottery screen 33 at a given probability. Specifically, lottery drawing is performed for each satellite 4 based on the random number sampled through a random number sampling circuit 78 (see FIG. 8) at the appropriate timing after the bet period expires and a bonus lottery pattern table 50 stored in the ROM 81 and if a bonus state (in which award odds of credit increase as compared with the normal gaming state) occurs at any one of the satellites 4 where the players play a game, the BET screens 31 at all satellites 4 make a transition to the bonus lottery screen 33.

As shown in FIGS. 4 and 5, the bonus lottery screen 33 is formed by causing a roulette display section 45 to overlap the BET screens 31. The roulette display section 45 has a magnification display section 46 provided on the circumference where nine types of numbers of “1,” “2,” “3,” “5,” “10,” “20,” “30,” “50,” and “100” are displayed in a total of 16 parts. A lottery cursor 47 is displayed on the magnification display section 46, pointing to any one of the numbers displayed on the magnification display section 46.

The lottery cursor 47 moves as it turns clockwise on the magnification display section 46 just after the BET screen 31 transits to the bonus lottery screen 33. For example, in FIG. 4, the lottery cursor 47 moves in the order of “100”→“1”→“5”→“2”→“30” and so on.

The lottery cursor 47 stops on a specific number after the expiration of a given time interval (in the embodiment, 10 seconds). The number on which the lottery cursor 47 stops is determined based on the result of lot drawing performed for each satellite 4 in the main control section 83 after the bet period expires. The lottery method is described later. FIG. 4 shows the state of the bonus lottery screen particularly while the lottery cursor is moving, and FIG. 5 shows the state of the bonus lottery screen particularly after the lottery cursor stops.

A lottery result display section 48 is provided roughly at the center of the roulette display section 45. After the lottery cursor 47 stops, the magnification corresponding to the number in the magnification display section 46 on which the lottery cursor 47 stops is displayed. For example, if the lottery cursor 47 stops on the number “2” in the magnification display section 46, “×2” is displayed (see FIG. 5). On the other hand, while the lottery cursor 47 is moving, “×?” is displayed (see FIG. 4).

The award odds if the player wins the game in betting the chip on the BET screen 31 (the credit pointss paid out per win chip) change in accordance with the magnification displayed on the magnification display section 46 (the magnification corresponding to the number on which the lottery cursor 47 stops). For example, if “×2” is displayed, credit points are paid out in accordance with the odds twice the normal award odds. If “×3” is displayed, credit points are paid out in accordance with the odds three times the normal award odds. If “×5” is displayed, credit points are paid out in accordance with the odds five times the normal award odds. If “×10” is displayed, credit points are paid out in accordance with the odds 10 times the normal award odds. If “×20” is displayed, credit points are paid out in accordance with the odds 20 times the normal award odds. If “×30” is displayed, credit points are paid out in accordance with the odds 30 times the normal award odds. If “×50” is displayed, credit points are paid out in accordance with the odds 50 times the normal award odds. If “×100” is displayed, credit points are paid out in accordance with the odds 100 times the normal award odds.

On the other hand, if “×1” is displayed, credit points are paid out in accordance with the normal award odds.

The normal award odds vary from one bet method to another using the BET screen 31 previously described. For example, if the player wins the game in the bet method of “straight up,” as many credit points as 36 times the number of bet chips are paid out to the player. If the player wins the game in the bet method of “corner bet,” as many credit points as eight times the number of bet chips are paid out to the player.

Therefore, when the BET screen 31 transits to the bonus lottery screen 33 and “×2” is displayed on the magnification display section 46, if the player wins the game in the bet method of “straight up” in betting chips on the BET screen 31, as many credit points as 72 times the number of bet chips are paid out to the player.

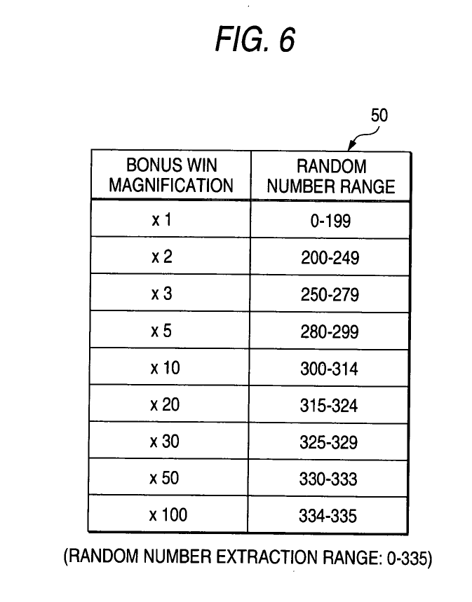

Herein, the bonus lottery pattern table 50 used for lot drawing in making a transition to the bonus state after the bet period expires will be discussed based on FIG. 6. FIG. 6 is a schematic representation to show the bonus lottery pattern table.

In FIG. 6, the range of the random numbers used in the bonus lottery pattern table 50 is “0” to “335” and when the bet period expires, the random number corresponding to each satellite 4 is sampled by the random number sampling circuit 78.

If the sampled random number is in the range of “200” to “249,” the bonus win magnification is “×2.” Therefore, the lottery cursor 47 stops on the number 2 in the magnification display section 46 on the bonus lottery screen 33. If the sampled random number is in the range of “250” to “279,” the bonus win magnification is “×3”. Therefore, the lottery cursor 47 stops on the number 3 in the magnification display section 46 on the bonus lottery screen 33. If the sampled random number is in the range of “280” to “299,” the bonus win magnification is “×5.” Therefore, the lottery cursor 47 stops on the number 5 in the magnification display section 46 on the bonus lottery screen 33. If the sampled random number is in the range of “300” to “314,” the bonus win magnification is “×10.” Therefore, the lottery cursor 47 stops on the number 10 in the magnification display section 46 on the bonus lottery screen 33. If the sampled random number is in the range of “315” to “324,” the bonus win magnification is “×20.” Therefore, the lottery cursor 47 stops on the number 20 in the magnification display section 46 on the bonus lottery screen 33. If the sampled random number is in the range of “325” to “329,” the bonus win magnification is “×30.” Therefore, the lottery cursor 47 stops on the number 30 in the magnification display section 46 on the bonus lottery screen 33. If the sampled random number is in the range of “330” to “333,” the bonus win magnification is “×50.” Therefore, the lottery cursor 47 stops on the number 50 in the magnification display section 46 on the bonus lottery screen 33. If the sampled random number is in the range of “334” to “335,” the bonus win magnification is “×100.” Therefore, the lottery cursor 47 stops on the number 100 in the magnification display section 46 on the bonus lottery screen 33. If the sampled random number is in the range of “0” to “199,” the bonus win magnification is “×1” and ends up blank. Therefore, the lottery cursor 47 stops on the number 1 in the magnification display section 46 on the bonus lottery screen 33. Further, if a blank occurs in all satellites 4 where the players are playing the game, the BET screen 31 does not make a transition to the bonus lottery screen 33.

The WIN lamp 10 of the satellite 4 where the win magnification becomes “×2” or more goes on after the lottery cursor 47 on the bonus lottery screen 33 stops. Each of the WIN lamps 10 can be visually recognized by the players from the positions of all satellites 4 as described above and when the BET screen 31 transits to the bonus lottery screen 33, the win magnification becomes “×2” or more (the state transits to the bonus state) at at least one satellite 4 or more and thus the player playing the game at each satellite 4 where the win magnification becomes “×1” (blank) can easily check which satellite 4 transits to the bonus state in the current game.

As described above, after the bet period expires at the satellite 4, lot drawing is performed as to whether or not the bonus state for increasing the award credit points (odds) when the player wins the game in betting chips as compared with the normal award odds is to be generated, and if the bonus state occurs at any one of the satellites 4 where the players play a game, the BET screen 31 at every satellite 4 transits to the bonus lottery screen 33, so that a sense of anticipation of the player for making a transition to the bonus state grows and the variety of game plays is increased and the player can continue to have interest in the game.

Further, on the bonus lottery screen 33, the lottery cursor 47 and the lottery result display section 48 are used to inform the player of the lottery result and the WIN lamp 10 is lit at the satellite 4 of the player making a transition to the bonus state. Thus, a sense of anticipation of the player increases as the effect of the lottery result is produced, and if a blank occurs, the player can easily check which satellite 4 transits to the bonus state in the current game.

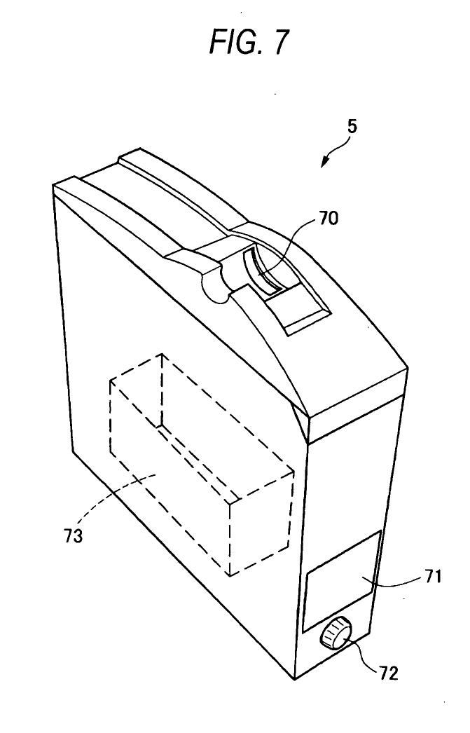

Next, the configuration of the medal acceptance unit 5 according to the embodiment will be discussed with FIG. 7. FIG. 7 is a perspective view to show the medal acceptance unit according to the embodiment.

As shown in FIG. 7, the medal acceptance unit 5 is a unit substantially shaped like a rectangular parallelepiped for inputting game media such as coins and medals, and accepting the game media. The credit points responsive to the accepted game media is added to the credit points owned by the player and the update is displayed in the credit points display section 38.

The medal acceptance unit 5 is provided with a medal insertion slot 70 for inputting a game media such as coins and medals, a medal return opening 71 for returning input medals to the player, and a key insertion slot 72 used to open and close the inside of the medal acceptance unit 5.

The key insertion slot 72 is an insertion slot of a key (not shown) for opening and closing a door (not shown) provided on the medal acceptance unit 5. When a predetermined key is inserted and is turned in a predetermined direction, the lock state of a locking unit is released and the door is opened. A medal storage section 73 for storing input medals is installed in the medal acceptance unit 5. As the door is opened, the medals in the medal storage section 73 can be collected. Further, it is also made possible to conduct internal maintenance.

Next, the configuration of a control system of the roulette gaming machine 1 will be discussed based on FIG. 8. FIG. 8 is a block diagram to schematically show the control system of the roulette gaming machine.

As shown in FIG. 8, the roulette gaming machine 1 includes a main control section 83 including a main control CPU 80, ROM 81, and RAM 82 and the roulette wheel 3 and the 10 satellites 4 connected to the main control section 83 (see FIG. 1). The control system of the satellite 4 is described later in detail.

The main control CPU 80 performs various types of processing based on input signals supplied from the satellites 4 and data and programs stored in the ROM 81 and the RAM 82, and transmits instruction signals to the satellites 4 based on the processing result, thereby controlling the satellites 4 under the initiative of the main control CPU 80 for advancing games. Further, the main control CPU 80 controls a win determination unit 84, a ball discharge unit 85, and a ball collection unit 86 installed in the roulette wheel 3 for discharging the ball 16 into the roulette wheel 3, collecting the ball 16 from the roulette wheel 3, and determining the win number corresponding to the ball housing groove 13 into which the ball 16 drops. The main control CPU 80 determines a win or loss of bet chips based on the obtained win number and bet information transmitted from each satellite 4 and calculates the credit points to be paid out to the player at the satellite 4. If the bonus state occurs, the credit points to be paid out to the player is increased in accordance with the win magnification in the bonus state (“×2” to “×100” ).

The ROM 81 is implemented as semiconductor memory and stores a program for providing the basic function of the roulette gaming machine 1, a program for controlling the units in the roulette wheel 3, the odds for a roulette game using the BET screen 31 (the credit payout number of chips responsive to a win per chip), the bonus lottery pattern table 50 (see FIG. 6), and a program for controlling the satellites 4 under the initiative of the main control CPU 80.

On the other hand, the RAM 82 temporarily stores chip bet information supplied from the satellites 4, the win number of the roulette wheel 3 determined by the win determination unit 84, and data concerning the result of the processing executed by the main control CPU 80.

The win determination unit 84, the ball discharge unit 85, and the ball collection unit 86 installed in the roulette wheel 3 are also connected to the main control CPU 80. If the bet time of the player at each satellite 4 expires, namely, if the BET timer graph 39 of the BET screen 31 reaches the rightmost side, the ball discharge unit 85 is driven for discharging the ball 16 into the roulette wheel 3.

When the rotation speed of the ball 16 gradually reduces and the ball 16 loses the centrifugal force, rolls down the slope of the frame 11, and is housed in any one of the ball housing groove 13, the win determination unit 84 determines the number described on the number indication plate 14 corresponding to the ball housing groove 13 in which the ball 16 is housed, and transmits the determination result to the main control CPU 80. Then, the ball collection unit 86 collects the ball 16 from the top of the roulette wheel 3.

A clock pulse generation circuit 75 for generating a reference clock pulse and a frequency divider 76 are connected to the main control CPU 80. Further, a random generator 77 for generating a random number and the above-mentioned random number sampling circuit 78 are connected to the main control CPU 80. The random number sampled through the random number sampling circuit 78 is used for drawing a lottery concerning occurrence of a bonus state. Specifically, after the bet period expires, lottery concerning occurrence of a bonus state is performed based on the random number sampled in the random number sampling circuit 78 and the bonus lottery pattern table 50, and the lottery result is transmitted to each satellite 4.

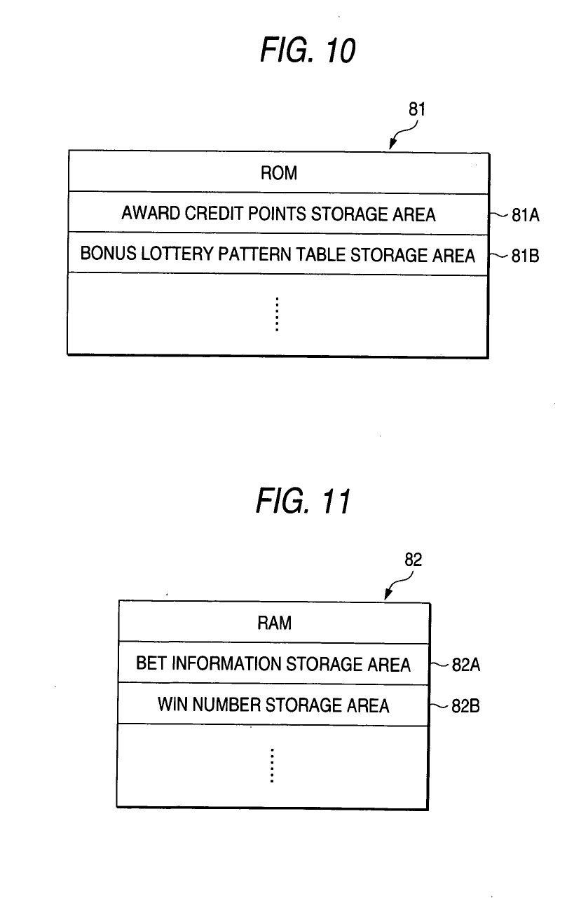

As shown in FIG. 10, the ROM 81 is provided with an award credit points storage area 81A storing the odds concerning a roulette game using the BET screen 31 and a bonus lottery pattern table storage area 81B storing the bonus lottery pattern table 50 to make a transition to a bonus state after the bet period expires. As the odds for each BET area 42 of the BET screen 31 stored in the award credit points storage area 81A, an award of “×2” to “×36” is predetermined and is stored depending on the bet method (straight up, corner bet, split bet, and the like). On the other hand, in the bonus lottery pattern table 50 stored in the bonus lottery pattern table storage area 81B, the odds for each BET area 42 described above are increased in the range of “×2” (twice) to “×100” (100 times).

The RAM 82 is provided with a bet information storage area 82A for storing the bet information of the player playing a game at present and a win number storage area 82B for storing the win number of the roulette wheel 3 determined by the win determination unit 84. The bet information specifically includes the BET areas 42 and the number of bet chips specified on the BET screen 31.

Next, the configuration of the control system of the satellite 4 connected to the CPU 80 of the main control section 83 will be discussed based on FIG. 9. FIG. 9 is a block diagram to schematically show the control system of the satellite 4 according to the embodiment. The 10 satellites 4 basically have the same configuration and therefore in the description to follow, one satellite 4 is taken as an example.

As shown in FIG. 9, the satellite 4 is basically including a main body 89 in which the image display 7 and the like are installed and the medal acceptance unit 5 attached to the main body 89. Further, the main body 89 is including a satellite control section 90 and several peripheral machines. The satellite control section 90 is including a satellite control CPU 91, ROM 92, and RAM 93. The ROM 92 is implemented as semiconductor memory, for example, and stores a program for providing the basic function of the satellite 4, various programs required for controlling the satellite 4, a data table, and the like. The RAM 93 is memory for temporarily storing various pieces of data on which operations are performed by the satellite control CPU 91, the current credit points owned by the player, the chip bet state of the player, and the like.

The BET confirmation button 22, the payback button 23, and the help button 24 placed on the control section 6 (see FIG. 1) are connected to the satellite control CPU 91. Based on an operation signal output as each button is pressed, etc., the satellite control CPU 91 controls the satellite to execute the corresponding operation. Specifically, the satellite control CPU 91 executes processing based on an input signal supplied from the control section 6 in response to entry of operation of the player and the data and the programs stored in the ROM 92 and the RAM 93, and transmits the processing result to the main control CPU 80 of the main control section 83 described above.

On the other hand, the satellite control CPU 91 receives an instruction signal from the main control CPU 80 and controls the peripheral machines making up the satellite 4 for advancing the roulette game in the satellite 4. Alternatively, the satellite control CPU 91 executes processing based on an input signal supplied from the control section 6 in response to entry of operation of the player and the data and the programs stored in the ROM 92 and the RAM 93, and controls the peripheral machines making up the satellite 4 for advancing the roulette game in the satellite 4. Which method the processing is to be performed according to is determined for each processing in response to the processing type. For example, medal payout processing responsive to the win number corresponds to the former type of processing and bet operation processing of the player on the BET screen 31 corresponds to the latter type of processing.

A hopper 94 is also connected to the satellite control CPU 91. The hopper 94 pays out a predetermined number of medals to the player from the medal payout opening 8 (see FIG. 1) in response to an instruction signal from the satellite control CPU 91.

The image display 7 is connected via a liquid crystal drive circuit 95 to the satellite control CPU 91. The liquid crystal drive circuit 95 includes program ROM, image ROM, an image control CPU, work RAM, a VDP (video display processor), and video RAM. The program ROM stores an image control program and various selection tables concerning display on the image display 7. The image ROM stores dot data to form images displayed on the image display 7. The image control CPU determines the image to be displayed on the image display 7 from the dot data previously stored in the image ROM in accordance with the image control program previously stored in the program ROM based on a parameter set in the satellite control CPU 91. The work RAM is implemented as temporary storage for the image control CPU to execute the image control program. The VDP forms an image responsive to the display determined by the image control CPU and outputs the image to the image display 7. The video RAM is implemented as temporary storage for the VDP to form an image.

The touch panel 28 is attached to the front of the image display 7 as mentioned above, and operation information of the touch panel 28 is transmitted to the satellite control CPU 91. Through the touch panel 28, the player bets chips on the BET screen 31 or the second BET screen 33. Specifically, the player operates the touch panel 28 in selecting the BET area 42, operating the screen switch button 34, the betting unit selection button 36, moving the cursor 55 to the selected number display sections 50A to 50C, the number-of-chips display section 57, pressing the numeric button 63, and the like, and touch panel operation information is transmitted to the satellite control CPU 91. Based on the information, the bet information of the current player (the BET areas 42 and the number of bet chips specified on the BET screen 31) is stored in the RAM 93 whenever necessary. The bet information is transmitted to the main control CPU 80 and is stored in the bet information storage area 82A of the RAM 82.

After the bet period expires and the bet information is transmitted to the main control CPU 80, the lottery result concerning occurrence of a bonus state (which of “×1” to “×100” is applied) is received from the main control section 83. If a transition is made to the bonus state at at least one satellite 4 where the player plays the game at present, namely, if “×2” or more is applied in the bonus lottery pattern table 50, the bonus lottery screen 33 is displayed at all satellites 4 and the effect of stopping the lottery cursor 47 based on the lottery result is produced and further at the satellite 4 where “×2” or more is applied to the player, the WIN lamp 10 connected to the satellite 4 is lit.

A sound output circuit 96 and the above-mentioned speaker 9 are connected to the satellite control CPU 91. The speaker 9 generates various effect sounds in making various effects based on output signals from the sound output circuit 96.

A data reception section 97 is also connected to the satellite control CPU 91 and further the medal acceptance unit 5 is connected to the data reception section 97. The medal acceptance unit 5 is a unit into which the player inputs game media of coins and medals, in playing a game, as mentioned above.

The data reception section 97 receives a credit signal transmitted from the medal acceptance unit 5. The credit signal is information concerning the added credit points based on the game media of coins, medals, etc., input into the medal acceptance unit 5. The satellite control CPU 91 increments the credit points of the player stored in the RAM 93 based on the received credit signal.

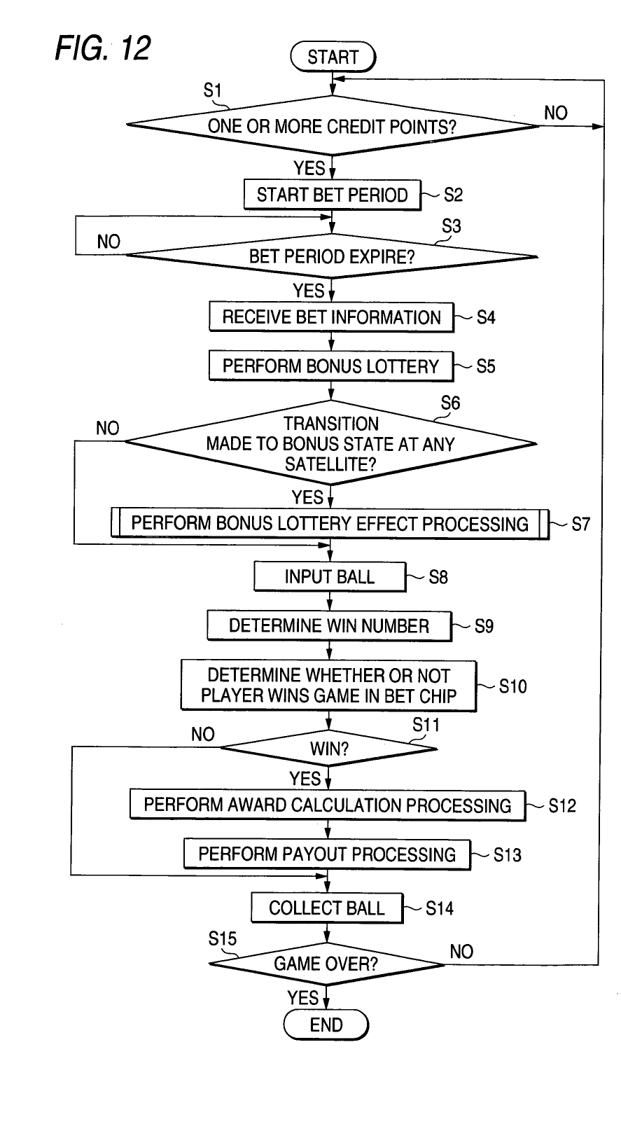

Subsequently, main processing program in the roulette gaming machine 1 will be discussed based on FIG. 12. FIG. 12 is a flowchart of the main processing program. The program shown in the flowchart of FIG. 12 is stored in the ROM 81 and the RAM 82 included in the roulette gaming machine 1 and is executed by the main control CPU 80.

First, at step 1 (S1), the main control CPU 80 determines whether or not the player owns one or more credit points. In the roulette gaming machine 1 according to the embodiment, when a medal or a coin is input into the medal acceptance unit 5 at any of the satellites 4, a medal input signal is sent from the satellite control section 90 of the satellite 4 to the main control section 83. According to the signal, the main control CPU 80 determines the input of the medal or the coin and increments the credit points owned by the player. The credit points incremented by the CPU 80 according to the number of input medals or coins, is recorded by the satellite control section 90 in the RAM 93 as the credit data indicative of the credit points. If no credit points is owned by the player (NO at S1), a wait mode is entered until the medal or the coin is input; if one or more credit points are owned by the player (YES at S1), the process proceeds to S2.

The BET screen 31 shown in FIG. 3 is displayed on the image display 7 of the satellite 4 used by the player, enabling the player to bet a chip. Other players can enter the game at midpoint and the roulette gaming machine 1 according to the embodiment allows a maximum of 10 players to play a game.

When the first player entering the game inputs a medal or a coin, the bet period in which each player can bet chip is started (S2). If the current game follows the preceding game, the bet period is started immediately after the preceding game is over. Each player entering the game can operate the touch panel 28 during the bet period to bet his or her chip on the BET area 42 corresponding to his or her predicted number (see FIG. 3). The specific bet method using the BET screen 31 is already described and therefore will not be discussed again.

Next, whether or not the bet period expires is determined at S3. The bet period is displayed with the BET timer graph 39. When the bet period starts (S2), the red graph starts to extend to the right gradually. When the red graph extends to the rightmost side, the bet period in the current game expires.

Before the bet period expires (NO at S3), bet is accepted. If the bet period expires (YES at S3), a bet end signal is output to the satellite control sections 90 of all satellites 4 and an image to the effect that the bet period expires is displayed on the liquid crystal screen 29 of each satellite 4, disabling each player from performing bet operation on the touch panel 28. The bet information of the player at each satellite 4 (specified BET area 42 and the number of bet chips on the specified BET area 42) is received (S4) and is stored in the bet information storage area 82A of the RAM 82.

Next, at S5, the main control CPU 80 acquires the random number from the random number sampling circuit 78 and performs lottery concerning occurrence of a bonus state for each satellite 4 based on the bonus lottery pattern table 50 stored in the bonus lottery pattern table storage area 81B.

Further, at S6, whether or not a transition is made to the bonus state at any satellite 4 is determined. Here, whether or not a transition is made to the bonus state is determined depending on whether or not “×2” or more is applied to the player at at least one satellite 4 (see FIG. 6). If a transition is made to the bonus state at at least one satellite 4 (YES at S6), effect processing concerning bonus lottery is performed at all satellites 4 (S7). The effect processing in bonus lottery at each satellite 4 is described later.

On the other hand, if a transition is not made to the bonus state at any satellites 4 (the lottery result is “×1”) (NO at S6), the process proceeds to S8.

Next, the main control CPU 80 executes lottery processing with the roulette wheel 3 in accordance with a game execution program. First, at S8, the ball discharge unit 85 discharges the ball 16 into the roulette wheel 3. The input ball 16 rolls on the roulette wheel 3 along the guide wall 18. Then, when the rotation speed reduces and the centrifugal force is lost, the ball 16 rolls down the slope of the frame 11 and goes inside the frame 11 and arrives at the rotating rotation disk 12 (see FIG. 2).

The ball 16 rolling to the rotation disk 12 is housed in any one of ball housing grooves 13 through the top of the number indication plates 14 outside the rotating rotation disk 12, and the number described on the number indication plate 14 corresponding to the ball housing groove 13 in which the ball 16 is housed (any of “0,” “00,” “1” to “36”) becomes the win number.

Subsequently, after the ball 16 is housed in the ball housing groove 13, the main control CPU 80 drives the win determination unit 84 for determining which number the ball is housed in the ball housing groove 13 corresponding to (S9).

Further, the main control CPU 80 determines whether or not the player at each satellite 4 wins the game in the bet chip from the bet information at each satellite 4 received at S4 and the win number determined at S9 (S10).

Whether or not the player at at least one satellite 4 wins the game in the bet chip is determined based on the win or loss determination at S10 (S11). If it is determined that the player at at least one satellite 4 wins the game in the bet chip (YES at S11), the main control CPU 80 executes award calculation processing (S12). In the award calculation processing, the win chip is recognized for each satellite 4 and the total award amount of credit paid out to the player at each satellite 4 is calculated using the odds for each BET area 42 stored in the award credit points storage area 81A of the ROM 81 (the credit points paid out per chip). Further, if a transition is made to the bonus state, the credit points to be paid out are increased in accordance with the win magnification (any of “×2” to “×100”) Then, the process proceeds to S13.

On the other hand, if it is determined that none of the players at the satellites 4 win the game in the bet chip (NO at S11), the process proceeds to S14.

At S13, credit payout processing is executed based on the award calculation processing at S12. To pay out credit to the player at the satellite 4, the main control section 83 outputs the credit data corresponding to the award amount to the satellite control section 90 of the satellite 4 of the winning player. The credit data is added to RAM 93 of the satellite 4 of the winning player.

At S14, the ball collection unit 86 installed below the rotation disk 12 collects the ball 16 on the rotation disk 12. The collected ball 16 will again be discharged to the roulette wheel 3 in the later game. Following S14, the process proceeds to S15.

At S15, whether or not the player at at least one satellite 4 continues to play a game is determined. To quit playing another game, normally the player presses the payback button 23. If the payback button 23 is pressed, as many medals as the number responsive to the credit points owned by the player at present gained by playing the game (normally, one medal per credit point) are paid back to the player from the medal payout opening 8.

If the player at any satellite 4 continues to play a game (NO at S15), the process returns to S1 and another bet period is started for starting another game.

On the other hand, if the players at all satellites 4 quit playing a game (YES at S15), the roulette game processing is terminated.

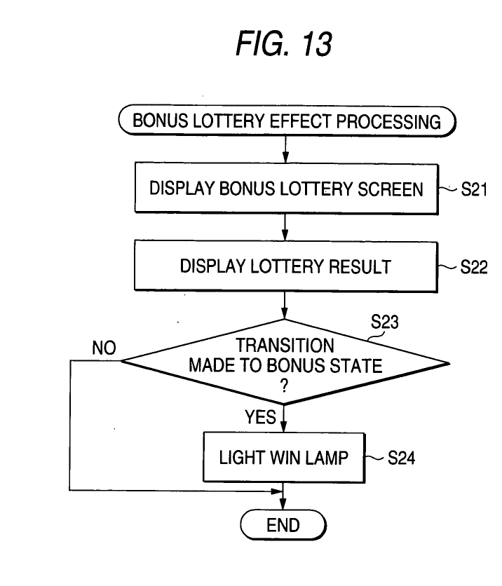

Next, a lottery effect processing program executed at the satellite 4 in the bonus lottery effect processing at S6 described above will be discussed below. FIG. 13 is a flowchart of the lottery effect processing program at the satellite. The program shown in the flowchart of FIG. 13 is stored in ROM 92 and the RAM 93 included in the satellite 4 and is executed by a satellite control CPU 91.

First, at S21, the satellite control CPU 91 causes the displayed BET screen 31 to make a transition to the bonus lottery screen 33 (see FIG. 4). The lottery cursor 47 on the roulette display section 45 displayed turns on the magnification display section 46 for a given time and then stops on any part of “1,” “2,” “3,” “5” “10,” “20,” “30,” “50,”or “100” of the magnification display section 46 according to the result of the lottery performed by the main control section 83 at S5 (S22) Further, the win magnification is specifically displayed on the lottery result display section 48 (see FIG. 5).

Next, at S23, whether or not a transition is made to the bonus state is determined. Making a transition to the bonus state means the case where the win magnification of the bonus lottery result becomes “×2” or more (see FIG. 6). If a transition is made to the bonus state (YES at S23), the WIN lamp 10 provided on the satellite 4 is lit (S24). Each WIN lamp 10 can be visually recognized by the players from the positions of all satellites 4 as described above and all players playing the game can easily check which satellite 4 transits to the bonus state in the current game.

In the gaming machine 1, a time period for lighting up the WIN lamp 10 or a timing to turn off the WIN lamp 10 may be configured arbitrary, however, in the embodiment, the WIN lamp 10 is configured to be turned off after the ball collection unit 86 collects the ball 16 on the rotation disk 12 at step S14.

On the other hand, if a transition is not made to the bonus state (NO at S23), the processing is terminated.

As described above, in the roulette gaming machine 1 according to the embodiment, after the bet period using the BET screen 31 expires, lot drawing is performed as to whether or not a transition is to be made to the special gaming state (bonus state) for increasing the award credit (odds) when the player wins the game in betting chips as compared with the normal award credit (S5), and if a transition is made to the bonus state at any one satellite 4 (YES at S6), at every satellite 4, the BET screen 31 transits to the bonus lottery screen 33 (S21). On the bonus lottery screen 33, the roulette display section 45 is used to inform the player of the lottery result concerning the transition to the bonus state in the roulette form (S22). Thus, a sense of anticipation of the player for making a transition to the bonus state grows and the variety of game plays is increased, so that the player can continue to have interest in the game.

Further, the WIN lamp 10 of the satellite 4 of the player making a transition to the bonus state is lit (S24). Thus, if a transition is not made to the bonus state, the player can easily check which satellite 4 transits to the bonus state in the current game.

The invention is not limited to the specific embodiment described above and various improvements and modifications can be made without departing from the spirit and the scope of the invention.

For example, in the embodiment, when a transition is made to the bonus state, the WIN lamp 10 of the corresponding satellite 4 is lit, but a display section includes 7-segment LEDs may be provided in place of the WIN lamp 10 for indicating not only whether or not a transition is made to the bonus state, but also the specific win magnification in the bonus state (any of “×2” to “×100”)

In the embodiment, the predetermined award credit responsive to the win chip is increased in the range of “×1” to “×100” based on the bonus lottery pattern table 50, but the award credit may be determined based on the bonus lottery pattern table 50.

In the embodiment, on the bonus lottery screen 33, the roulette display section 45 is used to inform the player of the lottery result concerning the transition to the bonus state in the roulette form, but symbols may be rotated as with a slot machine for informing the player of the lottery result.

In the embodiment, the satellite control CPU 91, liquid crystal drive circuit 95, the image display 7, the sound output circuit 96, and the speaker 9 serve as an effect producing unit that produces a special effect when the special gaming state occurs in at least one of the betting sections.

In the embodiment, the random generator 77, random number sampling circuit 78, and the main control CPU 80 serve as a lottery unit that performs a lottery for each of the betting sections, the lottery to win an occurrence of a special gaming state in which condition more advantageous than in a normal gaming state.

In the embodiment, the win magnification (such of “×2” or “×100”) are determined by the lottery to win the occurrence of the special gaming state. However, the gaming machine may be configured that a predetermined amount of credit points to be paid out to the player is determined by the lottery to win the occurrence of the special gaming state, instead of determining the win magnification. In this configuration, the amount of credit points won by the player is simply paid out to the player independent from the main game of the roulette game.

As described above, according to the embodiment, there is provided a gaming machine of the type wherein a plurality of players participate in a game, the gaming machine (for example, roulette gaming machine 1) including a game processing unit (for example, roulette wheel 3, ball 16, ball housing grooves 13) for players to play a game; a plurality of betting sections (for example, satellites 4) each for a player to bet a chip predicting the game result of the game processing unit; and payout unit (for example, main control CPU 80) for paying out credit points to the player at each betting section in response to the game result, wherein a special gaming state (for example, bonus state) for giving a more advantageous condition to each player than a normal gaming state occurs in each betting section, characterized by lottery unit (for example, main control CPU 80) for performing lot drawing of occurrence of the special gaming state in each betting section, characterized in that if the lottery unit causes the special gaming state to occur in at least one betting section, a predetermined effect (for example, bonus lottery screen 33) is produced in all betting sections.

According to the configuration described above, lottery concerning occurrence of the special gaming state for giving a more advantageous condition to each player than the normal gaming state in each betting section is performed and if the special gaming state occurs in at least one betting section, the predetermined effect is produced in all betting sections, so that a sense of anticipation of the player for occurrence of the advantageous condition is increased and the variety of game plays is increased, so that the player can continue to have interest in the game.

The special gaming state may be a state for increasing the amount of credit points paid out by the payout unit (for example, main control CPU 80) to the player at each betting section (for example, satellite 4) as compared with the normal gaming state.

According to the configuration, the special gaming state is a state for increasing the amount of credit points paid out by the payout unit to the player at each betting section as compared with the normal gaming state, so that a sense of anticipation of the player for increasing chip payout as compared with the normal chip payout is increased and the variety of game plays is increased, so that the player can continue to have interest in the game.

According to the embodiment, the players are informed of the lottery result of the lottery unit (for example, main control CPU 80) in the predetermined effect (for example, bonus lottery screen 33).

According to the configuration, the players are informed of the lottery result concerning occurrence of the special gaming state in the predetermined effect, so that it is made possible for the player to easily know the result not only in the case where the special gaming state occurs, but also in the case where the special gaming state does not occur, and the variety of game plays is increased, so that the player can continue to have interest in the game.

According to the embodiment, the betting section (for example, satellite 4) includes an indicator (for example, WIN lamp 10) for indicating occurrence of the special gaming state.

According to the configuration, the betting section includes the indicator for indicating occurrence of the special gaming state, so that the player playing the game and the surrounding players can easily know occurrence of the special gaming state in the betting section.

According to the embodiment, the indicator (for example, WIN lamp 10) is placed at the position for enabling the players at all betting sections (for example, satellites 4) to visually recognize the indicator.

According to the configuration, the indicator is placed at the position for enabling the players at all betting sections to visually recognize the indicator, so that all players playing the game with the same gaming machine can easily know which betting section the special gaming state occurs in.

According to the embodiment, the game processing unit (for example, roulette wheel 3, ball 16, ball housing grooves 13) includes a roulette wheel (for example, roulette wheel 3) on which a plurality of numbers are placed; and number lottery unit (for example, ball 16, ball housing grooves 13) for drawing a win number from among the plurality of numbers on the roulette wheel.

According to the configuration, the game processing unit includes the roulette wheel on which a plurality of numbers are placed and the number lottery unit for drawing a win number on the roulette wheel, so that the variety of game plays in the gaming machine for playing a roulette game is increased, a sense of anticipation of the player for playing the game is increased, and the player can continue to have interest in the game.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A gaming machine comprising:
a game processing unit that provides a game of a type in which a plurality of players participate;
a plurality of betting sections provided for each of the players, the betting section allowing the player to bet on a game result of the game provided by the game processing unit; and
a lottery unit that performs a lottery for each of the betting sections, the lottery to win an occurrence of a special gaming state in which condition more advantageous than in a normal gaming state,
wherein each of the betting sections includes an effect producing unit that produces a special effect when the special gaming state occurs in at least one of the betting sections.

2. The gaming machine according to claim 1, wherein the effect producing unit informs the player of a result of the lottery performed by the lottery unit in the special effect.

3. The gaming machine according to claim 1, wherein the effect producing unit includes a display that displays an image as the special effect.

4. The gaming machine according to claim 1, wherein each of the betting sections includes an indicator that indicates the occurrence of the special gaming state in the respective betting section.

5. The gaming machine according to claim 4, wherein the indicator includes a win lamp that lights up when the special gaming state occurs in the betting section.

6. The gaming machine according to claim 4, wherein the indicator is provided at a position for enabling the players at all of the betting sections to visually recognize the indicator.

7. The gaming machine according to claim 1, wherein the betting section includes a payout unit that pays out a predetermined amount of a credit points to the player in response to the game result.

8. The gaming machine according to claim 7, wherein the betting section allows the player to bet desired amount of the credit points owned by the player on the game result.

9. The gaming machine according to claim 8, wherein the betting section includes a game media acceptance unit that accepts game media input by the player, the game media depending on which a predetermined amount of the credit points are added to the credit points owned by the player.

10. The gaming machine according to claim 7, wherein the payout unit pays out more amount of the credit points to the player in the special gaming state than in the normal gaming state.

11. The gaming machine according to claim 1, wherein the game processing unit includes:
a roulette wheel on which a plurality of symbols are arranged; and
a symbol lottery unit that draws a lottery to determine a win symbol from among the symbols arranged on the roulette wheel.

12. The gaming machine according to claim 11, wherein the game processing unit provides to the player a main game of a roulette game,
wherein the betting section allows the player to bet on at least one of the symbols arranged on the roulette wheel in the main game, and
wherein the game processing unit determines whether or not the symbol on which the player bet with the betting section matches with the win symbol determined by the symbol lottery unit.

13. A gaming method comprising:
providing a game of a type in which a plurality of players participate;
allowing each of the players to bet on a game result of the game with a plurality of betting sections respectively provided for each of the players;
performing a lottery for each of the betting sections, the lottery to win an occurrence of a special gaming state in which condition more advantageous than in a normal gaming state;
producing a special effect in each of the betting sections when the special gaming state occurs in at least one of the betting sections.
